(19) United States
(12) Patent Application Publication
(10) Pub. No.: US 2021/0083496 A1
(43) Pub. Date: Mar. 18, 2021

(54) Battery Management System

(71) Applicant: Malik Honiston, Clinton Township, MI (US)

(72) Inventor: Malik Honiston, Clinton Township, MI (US)

(21) Appl. No.: 17/039,654

(22) Filed: Sep. 30, 2020

Related U.S. Application Data
(60) Provisional application No. 62/880,177, filed on Jul. 30, 2019.

(51) Int. Cl. H02J 7/00; H02J 7/34; H02J 7/02; H02J 50/10

(52) U.S. Cl. CPC H02J 7/0047; H02J 50/10; H02J 7/02; H02J 7/342

(57) ABSTRACT

A battery management system including a memory, at least one processor and a battery management controller. The battery management controller is configured to receive a battery transaction request from a home device, identify a source device and a target device for the battery transaction request, determine an amount of battery charge to receive from a source device for a receive battery transfer request and determine an amount of battery charge to send to a target device for a send battery transfer request, initiate a battery transaction consistent with the battery transaction request, determine whether the determined amount of battery charge to receive from a source device for a receive battery transfer request or whether the determined amount of battery charge to send to a target device for a send battery transfer request has occurred and terminate the battery transaction when the determined amount of battery charge for a corresponding battery transaction request has occurred.

### CROSS-REFERENCE TO RELATED APPLICATIONS

This application claims the benefit of priority of U.S. Provisional Application No. 62/880,177 filed on Jul. 30, 2019, the disclosure of which is incorporated herein by reference in its entirety.

### FIELD OF THE INVENTION

Embodiments described herein generally relate to batteries, and more particularly to a battery management system.

### BACKGROUND OF THE INVENTION

Conventionally when an individual's phone runs out of battery, they need to have an adapter and an outlet available in order to charge it. This can be problematic for individuals who are constantly on the go as those resources may not be readily available as their battery begins to die. Hence, it is desirable to provide individuals with the ability to keep their mobile devices charged throughout the course of the day.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a battery management system according to an embodiment of the present disclosure.

FIG. 2 illustrates a method for performing battery management operations in accordance with an exemplary embodiment of the present disclosure.

### SUMMARY OF THE INVENTION

The present disclosure relates to a battery management system. The system allows individuals to get the ultimate performance from their phone's battery. The system conserves an individual's battery by closing out unused mobile apps running on their device. The system also allows individuals to use a peer to peer cord to siphon battery from another individuals' mobile phone. Additional features and utilities of the present general inventive concept will be set forth in part in the description which follows and, in part, will be obvious from the description, or may be learned by practice of the general inventive concept.

### DETAILED DESCRIPTION

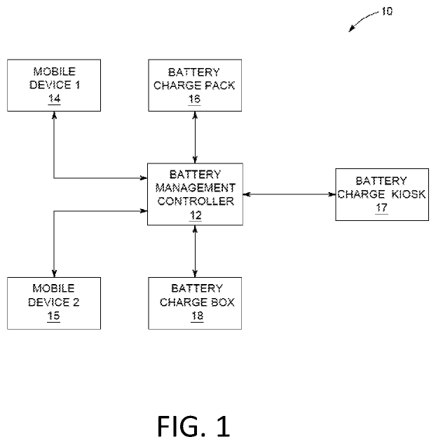

As illustrated in FIG. 1, the battery management system (“the system”) 10 includes a battery management controller 12, mobile1 dev 14, mobile2 dev 15, battery charge pack 16, battery charge kiosk 17, battery charge box 18, and one or more connection cables (not shown). The battery management controller 12 may include at least one memory storage device, one or more processors, and one or more modules or software applications processed by the one or processors, including a mobile application for managing the battery in a device. The one or more processors may include a central processing unit, a graphics process, a coprocessor, etc. The device may include any portable rechargeable devices. In a preferred embodiment, the device is a mobile phone.

The battery management controller 12 may reside in any battery charge consumer device (i.e., a device that consumes battery charge) or supplier device (i.e., a device that provides battery charge), such as, for example, mobile1 dev 14, mobile2 dev 15, battery charge pack 16, battery charge kiosk 17, and battery charge box 18. The battery management controller may include a memory, at least one processor and a plurality of computer executable instructions (battery management controller application)(APP) that are configured to cause the at least one processor to perform battery management operations (e.g., battery charge send/transfer processes, battery charge receive processes, and battery charge conserve processes). Moreover, the battery management controller 12 monitors a device's amount of battery charge on an ongoing basis and outputs the battery charge status on the device's display to inform the user of the device.

Mobile1 dev 14 and mobile2 dev 15 may each include a mobile phone, such as, for example, a smart phone. The smart phone may include memory, at least one processor and at least one mobile application (APP) for interfacing with battery charge pack 16, battery charge kiosk 17, and battery charge box 18. The at least one processor executes the computer instructions of the mobile application to effectuate the various functions described herein which are performed or provided by the mobile application for managing the battery in a device.

Each mobile device (i.e., mobile1 dev 14, mobile2 dev 15) may include a battery fuel gauge which keeps track of the charge state of battery. The battery fuel gauge may include a coulomb counter to measure how fast energy is leaving every second, and adding it to a running total to determine how much electricity is in the battery. Moreover, each mobile device may include at least transmit coil and at least one receive coil. The at least one transmit coil in one device (e.g., mobile1 dev 14) can pair/connect with the at least one receive coil in a second device (e.g., mobile2 dev 15) when in close proximity to one another to effectuate wireless charging (i.e., inductive charging) from mobile1 dev 14 (i.e., the initiating device having the at least one transmit coil) to mobile2 dev 15 (i.e., the designated receiving device having the at least one receive coil).

The battery charge pack 16 may include a mobile device protective case (i.e., housing) having integrated therein a plurality of rechargeable batteries, a control circuit (e.g., a lithium battery charger board protection module) to control power in and power out, and a universal serial bus (“USB”) connector for connection to another device (e.g., an electrical outlet or a mobile device). The batteries may be configured in a series, parallel or a mixture of both to deliver the desired voltage, capacity, or power density. The battery charge pack 16 can be a portable battery charge device. The battery charge pack may charge a mobile device when the mobile device touches the battery charge pack directly by laying on a surface of the battery charge pack or by connecting a cable to the battery charge pack 16 and to the mobile device.

The battery charge kiosk 17 (“kiosk”) is a floor standing charging station which includes multiple charging cords (which each is configured to connect directly to a target device) for charging multiple mobile devices. The battery charge kiosk may be located in any public location, such as, for example, the airport, shopping mall, sports stadium, concert venue, etc. The kiosk may be integrated with electronic pads that need to touch (i.e., connect to) a mobile device (e.g., mobile1 dev 14, mobile2 dev 15) to charge the mobile device. The electronic pads work by creating a small electromagnetic field between the kiosk and the mobile device when a connection is established between the kiosk and the mobile device which causes inductive charging to take place between the kiosk and the mobile device.

The battery charge box 18 is a portable charging box that is charged by a power source. Once the charging box is charged, the box may be used to charge mobile1 dev 1 14 or mobile2 dev 15 with a connection cable. The box 18 will send a text to the target device indicating the amount of battery charge it has and how much battery charge it can transfer to the target device.

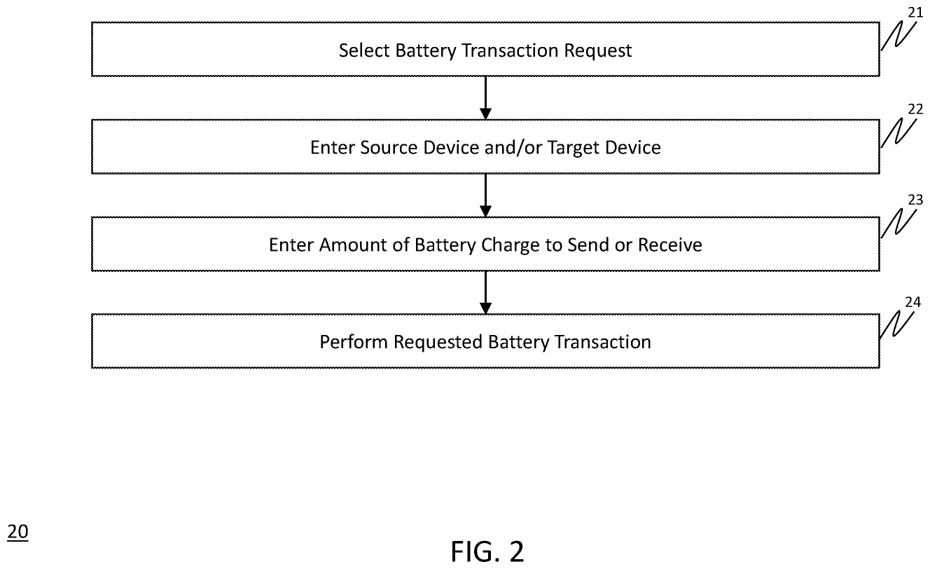

FIG. 2 illustrates a method 20 for performing battery management operations in accordance with an exemplary embodiment of the present disclosure. In operation, a user may download the battery management controller application (APP) to the user's mobile device. Each target device and source device may include the APP and/or an interface to the APP to effectuate battery transactions between the target and source devices. The APP includes a graphical user interface which may be displayed on the target device (i.e., mobile 1 dev 14 or mobile2 dev 15) and the source device (i.e., mobile 1 dev 14 or mobile2 dev 15 or battery charge pack 16 or battery charge kiosk 17 or battery charge box 18) to receive inputs/requests from the user. The battery management controller 12 performs a battery charge send/transfer process or a battery charge receive process upon initiation by a user of a device using the APP.

At step 21, a user may select a type of battery transaction (i.e., a battery transaction request), such as, for example, send battery charge from the home source device to a target device (i.e., a send battery transfer request) and receive at the home target device battery charge transferred from a source device (i.e., a receive battery transfer request). The home device is the device operated by the user (e.g., mobile1 dev 14 or mobile2 dev 15). The home device can be a target device in a receive battery transfer transaction or a source device in a send battery charge transaction. The user may use the graphical user interface to select the transaction type. At step 22, the user may enter a source and/or target device. The user may identify the target device or source device by providing the phone number or the contact information associated with the target device or source device for peer to peer transfers (i.e., between mobile1 dev 14 and mobile2 dev 15). In embodiments, the APP may automatically designate the home device as the target device when the home device initiates a receive battery transfer request, and the APP may automatically designate the home device as the source device when the home device initiates a send battery transfer request.

When a target device is receiving battery charge from battery charge pack 16, battery charge kiosk 17, or battery charge box 18, the user may provide identification information by entering a name designated for the source device. The target and source devices may be connected using one or more of the connection cables. For peer to peer processes, the devices may be connected using on-the-go (OTG) cables. For other connections, any suitable connection cable may be used or no connection cable may be used if the device is able to establish a connection with the target/source device without a connection cable.

At step 23, the user may enter the amount of battery charge to transfer or receive. This amount may be entered in percentages, such as, for example, 5%. For non-peer to peer battery charge receive processes, such as, for example, a receive process between mobile1 dev 14 or mobile2 dev 15 and any one of battery charge pack 16, battery charge kiosk 17, and battery charge box 18, entering the battery charge amount is optional. The user may leave the battery charge amount empty and the device will continue to receive/send battery charge from/to the home source device/home target device, so long as the home source device/home target device does not lose power, until the user disconnects the connection.

At step 24, the at least one processor in the battery management controller 12 executes a plurality of computer executable instructions to perform the requested battery transaction including: receive a battery transaction request from a home device, the battery transaction request including a receive battery transfer or a send battery transfer request; identify a source device and a target device for the battery transaction request; determine an amount of battery charge to receive from a source device for a receive battery transfer request and determine an amount of battery charge to send to a target device for a send battery transfer request; initiate a battery transaction consistent with the battery transaction request; determine whether the determined amount of battery charge to receive from a source device for a receive battery transfer request or whether the determined amount of battery charge to send to a target device for a send battery transfer request has occurred; and to terminate the battery transaction when the determined amount of battery charge for a corresponding battery transaction request has occurred.

The battery management controller 12 may initiate a requested battery transaction by instructing the user to operate the home device in a particular manner. For example, the battery management controller may instruct the user to connect the home target device (e.g., mobile1 dev 14 or mobile2 dev 15) to a source device (e.g., a mobile device, battery charger pack 16, battery charge kiosk 17 or battery charge box 18) or to connect the home source device to a target device. When the home device is connected to a battery charger pack 16 source device, the home device may be connected by touching the battery charge pack directly by laying on a surface of the battery charge pack or by connecting a cable to the battery charge pack 16 and to the mobile device. When the home device is connected to a battery charger kiosk 17 source device, the home device may be connected by attaching the home device to one of the charging cords integrated within the device. When the home device is connected to a battery charger box 18 source device, the home device may be connected to the battery charger box using a connection cable.

When the target device and the source device are both peer devices (i.e., mobile devices), a peer-to-peer wireless power transfer (i.e., wireless battery charging) from a source device (e.g., mobile1 dev 14) to a target device (e.g., mobile2 dev 15) may be performed using the battery management controller 12. The battery management controller 12 may interface with a peer device's at least one transmit coil and/or at least one receive coil to transmit electrical energy from the source device to a target device or to receive electrical energy at a target device from a source device without wires as a physical link.

In this instance, the battery management controller 12 may instruct the user to position the target device within a predetermined proximity to the source device to establish a connection between the at least one receive coil (e.g., Qi receive coil) in the target device and the at least one transmit coil (e.g., Qi transmit coil) in the source device. These coils are inductively coupled (i.e., a wireless connection is established between the target device and the source device) when the devices are positioned within a predetermined proximity of one another which causes the AC current (i.e., electrical energy) in the transmit coil to generate a magnetic field that induces a voltage in the receive coil.

In embodiments, a portable and detachable dial hardware device may be attached to a connector on a peer target device and a peer source device to effectuate peer-to-peer wireless power transfers. Each dial hardware device may include a transmitter and a receiver for transmitting and receiving electrical energy respectively. The transmitter may include at least one transmit coil and the receiver may include at least one receive coil. Other suitable types of transmitters and receivers may be included in each dial hardware.

Once a connection is made between the target device and the source device, the battery charge transfer process starts instantly. Once the battery charge transfer process is initiated, the battery management controller 12 manages the transfer/receipt of battery charge in accordance with the battery charge amount, if any. The battery management controller may determine the target device, source device and amount of battery charge to send or receive for a battery transaction based on the inputs received from the user.

The battery management controller 12 may determine whether the determined amount of battery charge to receive from a source device for a receive battery transfer request or whether the determined amount of battery charge to send to a target device for a send battery transfer request has occurred by interfacing with the home device's battery fuel gauge to determine how much battery charge a home source device transferred or a home target device received.

So, for example, if a user enters an amount of 30% charge to receive at the home target device from a source device (i.e., receive battery transfer request/transaction) the battery management controller 12 may check the battery fuel gauge to determine the current amount of battery charge of the home target device (i.e., precharge battery amount) and may monitor the battery fuel gauge until it reaches an amount equal to the precharge battery amount plus 30% (i.e., desired post charge battery amount).

Alternatively, if a user enters an amount of 30% to send from a home source device to a target device (i.e., send battery transfer request/transaction), the battery management controller may check the battery fuel gauge to determine the current amount of battery charge of the home source device (i.e., precharge battery amount) and may monitor the battery fuel gauge until it reaches an amount equal to the precharge battery amount minus 30% (i.e., desired post charge battery amount). Once the home target device receives the desired post charge battery amount, the battery management controller may terminate the battery transfer transaction. Moreover, once the home source device has transmitted the desired post charge battery amount, the battery management controller may terminate the battery transfer transaction.

As noted, a user may leave the battery charge amount empty for a receive battery transfer request or send battery transfer request. In this instance, the home target device will continue to receive battery charge from the source device, so long as the source device does not lose power, until the user disconnects the connection. Likewise, for a send battery transfer request, the home source device will continue to send battery charge from the home source device, so long as the home source device does not lose power, until the user disconnects the connection. When the user disconnects the connection, the battery management controller 12 terminates the battery transaction.

Once the process is complete (i.e., the battery transaction is terminated), the user of the home target device is asked whether they want to use the received battery charge at that time or if they want to wait to use it. Thereafter, the battery management controller 12 adjusts the battery charge status and displays the new battery charge status to the user.

In embodiments, a user may request a battery charge transfer from a single source device to multiple target devices. The mobile application (APP) may allow the user to set up a battery transfer from a single device (i.e., source device) to multiple devices (i.e., target devices). The APP may also allow the user to enter the amount of battery charge to transfer to each target device for a multiple device transfer.

In embodiments, the battery management controller 12 may perform a battery charge conserve process by closing unused applications running on the corresponding device. At predetermined time intervals, the controller 12 monitors the open applications on the device to determine which applications, if any, have been idle for a predetermined period of time. Once an application is found that has been idle for a predetermined amount of time, the controller 12 closes the application. The battery charge conserve process can be enabled for the device using the mobile application for managing the battery.

While various embodiments disclose a mobile application, it should be noted that a web-based application or online application may also be used in lieu of the mobile application to perform the same functionalities described in the present disclosure for the mobile application.

While example embodiments have been disclosed relating to mobile devices, other devices may also be used such as, tablets.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A battery management system comprising:
a memory;
at least one processor;
a battery management controller including a plurality of computer executable instructions configured to cause the at least one processor to:
receive a battery transaction request from a home device, the battery transaction request including a receive battery transfer or a send battery transfer request;
identify a source device and a target device for the battery transaction request;
determine an amount of battery charge to receive from a source device for a receive battery transfer request and determine an amount of battery charge to send to a target device for a send battery transfer request;
initiating a battery transaction consistent with the battery transaction request;
determining whether the determined amount of battery charge to receive from a source device for a receive battery transfer request or whether the determined amount of battery charge to send to a target device for a send battery transfer request has occurred;
terminating the battery transaction when the determined amount of battery charge for a corresponding battery transaction request has occurred.

2. The system of claim 1, wherein the target device is a mobile device.

3. The system of claim 1, wherein the source device is at least one from a group comprising i.) a mobile device, ii.) a battery charge kiosk, iii.) a battery charge pack, and iv.) a battery charge box.

4. The system of claim 1, wherein a peer-to-peer wireless power transfer is performed when the target device and the source device are both mobile devices.

5. The system of claim 1, wherein the battery management controller performs a battery charge conserve process.

6. The system of claim 1, wherein the battery management controller performs a battery charge conserve process automatically or upon request.

7. The system of claim 5, wherein the battery management controller performs a battery charge conserve process by closing unused applications running on the corresponding device.
